(19) United States
(12) Patent Application Publication
(10) Pub. No.: US 2011/0188954 A1
(43) Pub. Date: Aug. 4, 2011

(54) BORING TOOL

(75) Inventor: Peter Frank, Floh-Seligenthal (DE)

(73) Assignee: SANDVIK INTELLECTUAL PROPERTY AB, Sandviken (SE)

(21) Appl. No.: 13/054,451

(22) PCT Filed: Jul. 9, 2009
(86) PCT No.: PCT/EP2009/058620

§ 371 Date: Apr. 8, 2011

(30) Foreign Application Priority Data
Jul. 18, 2008 (DE) 10 2008 040 561.2

(51) Int. Cl. B23B 29/034

(52) U.S. Cl. 408/181; 408/186

(57) ABSTRACT

The present invention concerns a boring-out tool comprising a main tool body having an interface for a drive, and a cutting insert holder which can be fastened to the main tool body and has a seat for a cutting insert, wherein the cutting insert holder can be moved in the radial direction relative to the main tool body between two positions. To provide a boring-out tool of the kind set forth in the opening part of this specification, which can be easily adapted to different boring diameters so that only few different boring-out tools have to be stocked to be able to cover all usual boring diameters, it is proposed in accordance with the invention that there is provided an extension arm which on the one hand is fastened to the main tool body and which on the other hand carries the cutting insert holder, wherein the cutting insert holder can be fastened to the extension arm at least two positions which are spaced from each other in the radial direction.

The invention concerns a boring-out tool comprising a main tool body having an interface for a drive, and a cutting insert holder which can be fastened to the main tool body and has a seat for a cutting insert, wherein the cutting insert holder can be reciprocated in the radial direction relative to the main tool body between two positions, wherein the cutting insert holder can be fixed generally in the two positions and mostly also in all intermediate positions on the main tool body.

Such a boring-out tool is known from DE 103 15 394 A1. The interface to a drive can be a drive shaft. It will be appreciated however that all other couplings are also possible.

Such a tool serves for example for enlarging a pre-worked bore.

During the machining operation the tool rotates about a central axis, also referred as the boring axis, which is substantially perpendicular to the end face of the main tool body. When the tool engages into a pre-worked bore the cutting inserts carried on the cutting insert holders come into engagement with the internal contour of the bore, enlarge it and possibly perform final machining of the internal surfaces.

In the known boring tools the boring diameter can be varied by the cutting insert holders being displaced in the radial direction, that is to say perpendicularly to the borer axis, to a limited extent.

Naturally however that displacement is only possible over a limited range so that only a given boring diameter range can be covered with a boring-out tool.

If markedly larger or markedly smaller boring diameters are to be implemented, a different boring-out tool has to be used.

That not only increases the production costs but also the costs linked to maintaining stocks as now a suitable boring-out tool has to be kept in readiness for each diameter range. As however the boring diameter can vary greatly, for example up to 2 m in size, but can be even greater, a corresponding number of different boring-out tools have to be constructed and kept ready.

Therefore, taking that state of the art as the basic starting point, the object of the present invention is to provide a boring-out tool of the kind set forth in the opening part of this specification, which can be easily adapted to different boring diameters so that only few different boring-out tools have to be stocked to be able to cover all usual boring diameters.

According to the invention that object is attained in that there is provided an extension arm which on the one hand is fastened to the main tool body and which on the other hand carries the cutting insert holder, wherein the cutting insert holder can be fastened to the extension arm at least two positions which are spaced from each other in the radial direction.

In other words the cutting insert holder is now no longer fastened directly to the main tool body but to an extension arm which in turn is fastened to the main tool body. The cutting insert holder can be moved to a limited extent relative to the extension arm in the radial direction to cover a predetermined boring diameter range. If the boring diameter is to be markedly increased or reduced then the extension arm can be replaced by a shorter or longer extension arm.

That considerably reduces the number of necessary boring-out tools to cover all usual boring diameters.

In an embodiment the boring-out tool has two, three, four or more cutting insert holders which can be fastened to the main tool body by means of extension arms and each have at least one seat for at least one cutting insert and can be respectively reciprocated in the radial direction relative to an extension arm and thus the main tool body between two positions, wherein the main tool body has a hub portion and a plurality of spoke portions corresponding to the number of cutting insert holders, wherein the spoke portions extend radially substantially perpendicularly to the boring axis and wherein preferably the sides of the spoke portions, that are remote from the hub portion, are connected to the wheel-shaped portion which connects all spoke portions.

In other words in this embodiment the main tool body is substantially in the form of a steering wheel, wherein the extension arms are fastened to the spoke portions and/or the wheel-shaped portion in such a way that the cutting insert holders and in particular the cutting inserts accommodated therein project in the radial direction beyond the steering wheel so that in the boring-out operation only the cutting inserts and not the main tool body comes into contact with the workpiece to be machined.

In a further embodiment the cutting insert holder has at least one slot and can be fastened to the extension arm by means of at least one screw which engages through the slot into a threaded bore in the extension arm, wherein the cutting insert holder can be fastened at different positions by releasing the screw, radially displacing the cutting insert holder and tightening the screw.

Alternatively or in combination therewith the cutting insert holder can have at least one through hole and can be fastened to the extension arm by means of a screw which engages through the slot into a threaded bore in the extension arm, wherein the extension arm has at least two threaded bores arranged in such a way that the cutting insert holder can be fastened at different positions using the different threaded bores.

In other words either the cutting insert holder can be screwed fast at different threaded bores in the extension arm to assume different radial positions for the cutting insert holder relative to the extension arm or radial adjustment of the cutting insert holder can be effected by radial displacement of the cutting insert holder with respect to the extension arm within the limits of the freedom of movement afforded by a slot.

It will be appreciated that to still further increase radial adjustability it is also possible both to provide a plurality of threaded bores in the extension arm and also to equip the cutting insert holder with a slot.

Preferably the boring-out tool has at least two extension arms of differing length in the radial direction or at least two different sets of extension arms of differing length, which can be fastened selectively between cutting insert holder and main tool body to implement different boring diameter ranges. Even if in principle the boring-out tool can be used with only one extension arm or set of extension arms of the same length, the provision of further extension arms of differing lengths enlarges the boring diameter range which can be covered with the boring-out tool.

It can further be provided that the boring-out tool has at least two main tool bodies with spoke portions of differing length, which can be selectively used for receiving the extension arm to implement different boring diameter ranges. In that way it would be possible for example to provide main tool body diameters of between 250 and 1500 mm.

In addition, in a section plane perpendicularly to the boring axis, the extension arm can have at least one—preferably two mutually opposite—portion which is inclined or angled with respect to the radial direction, wherein the angle of inclination, that is to say the angle which the inclined portion includes with the radial direction, is preferably about 45° or about 180°/n, wherein n is the number of extension arms which can be fastened on the main tool body. By virtue of that measure, the extension arms can be further displaced in the direction towards the boring axis without striking against each other, whereby the boring diameter range which can be implemented with the boring-out tool is further increased.

In a further embodiment the extension arm has a groove extending substantially in the radial direction and the cutting insert holder has a corresponding leg-like projection extending substantially in the radial direction, wherein the leg-like projection can be inserted into the groove. It will be appreciated that in principle it would also be possible for the extension arm to have a leg-like projection and for the cutting insert to have a corresponding groove.

It has been found that the cutting forces during the boring-out operation are best carried if the groove has at least one groove wall which is inclined relative to a notional plane passing through the boring axis, wherein the angle of inclination is preferably between 1 and 20°.

In addition it has proven to be advantageous if the cutting insert holder comprises a slider body and a holding element accommodated in the slider body, wherein the holding element has a receiving means for the cutting insert. In that respect there can additionally be provided a device for axial displacement of the holding element within the receiving means of the cutting insert.

Further advantages, features and possible uses will be apparent from the description hereinafter of a preferred embodiment and the accompanying drawings in which:

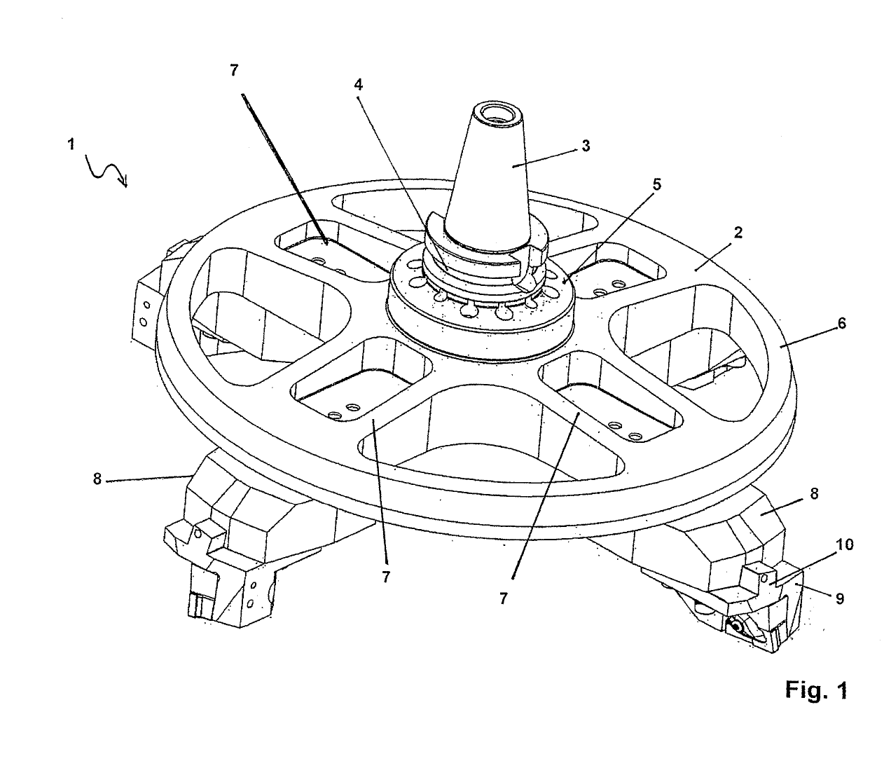

FIG. 1 shows a perspective view of a first embodiment of the invention,

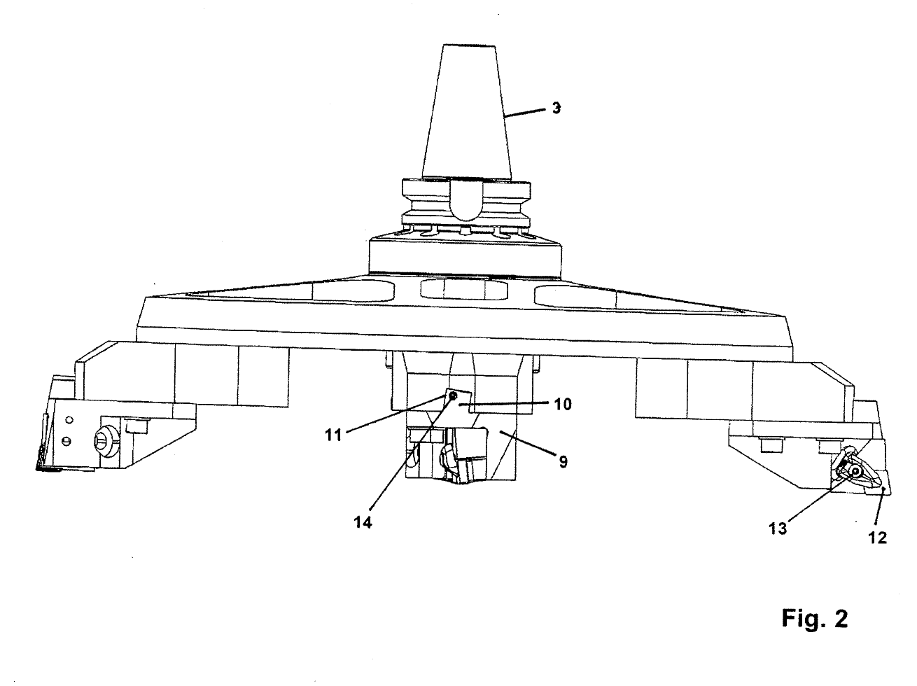

FIG. 2 shows a side view of the FIG. 1 embodiment,

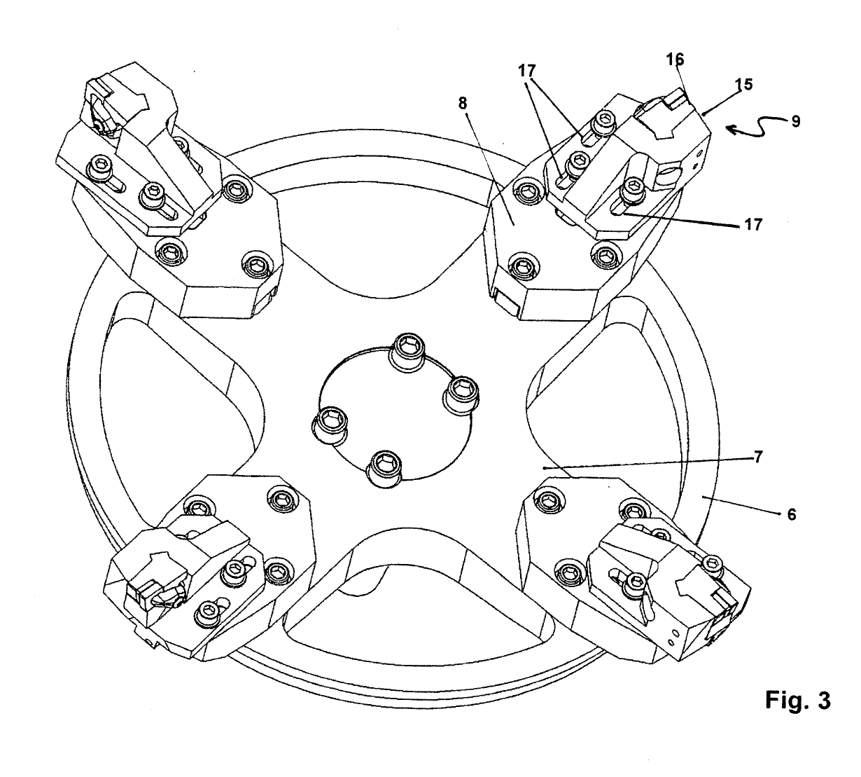

FIG. 3 shows a further perspective view of the FIG. 1 embodiment,

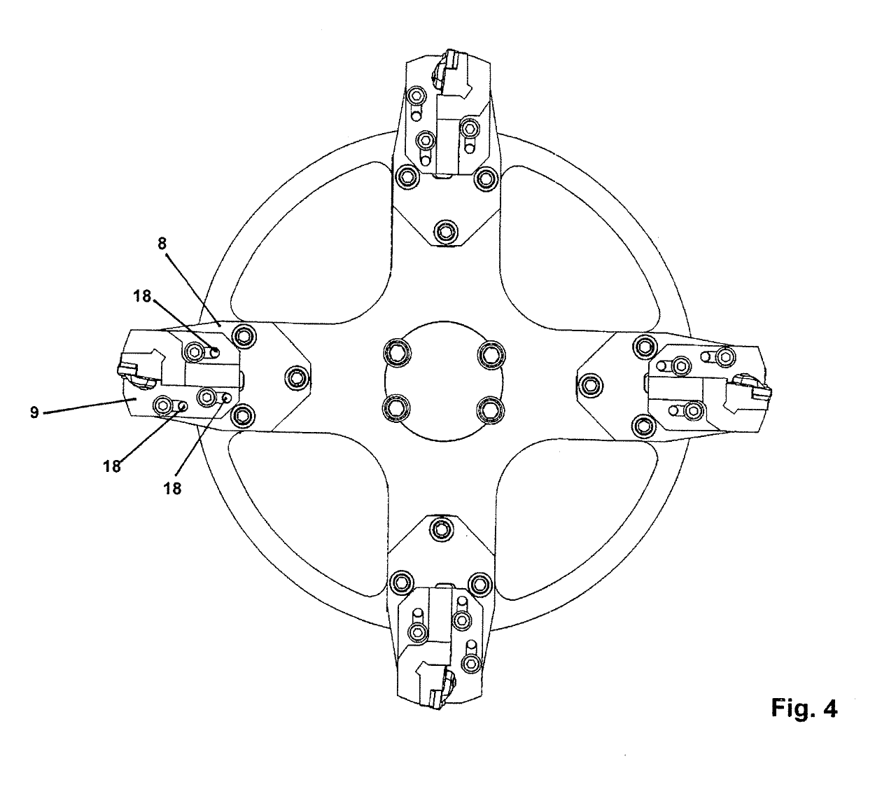

FIG. 4 shows a view from below of the FIG. 1 embodiment,

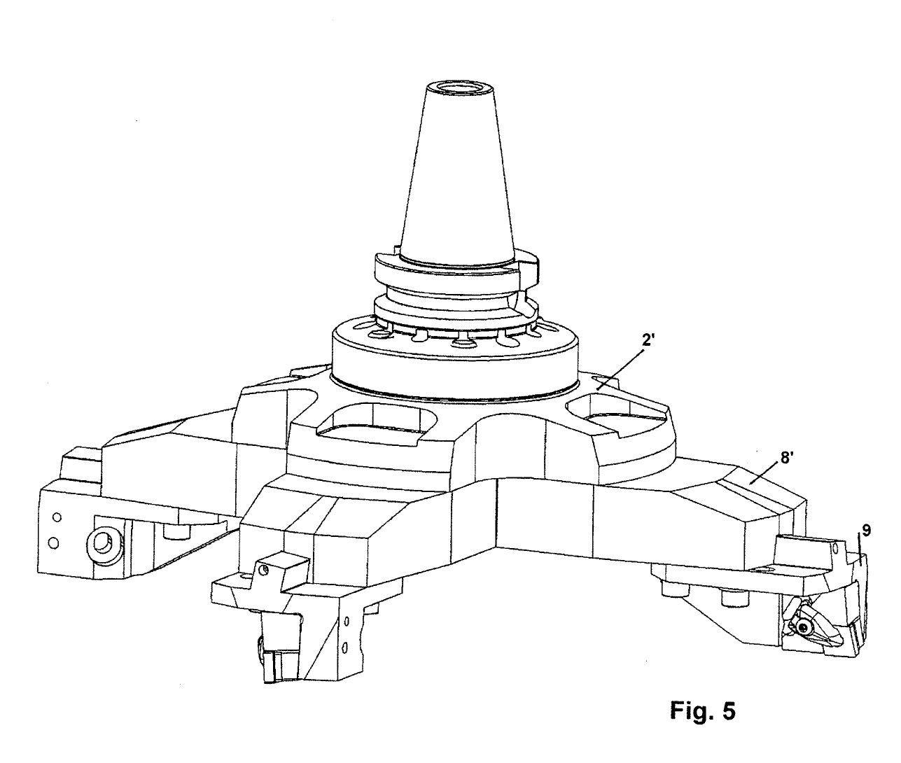

FIG. 5 shows a side view of a second embodiment,

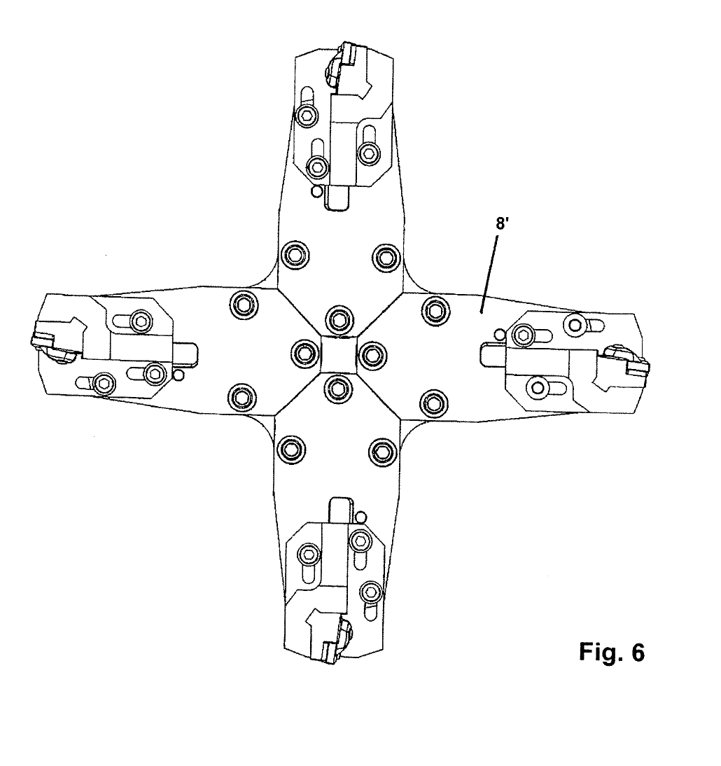

FIG. 6 shows a view from below of the FIG. 5 embodiment,

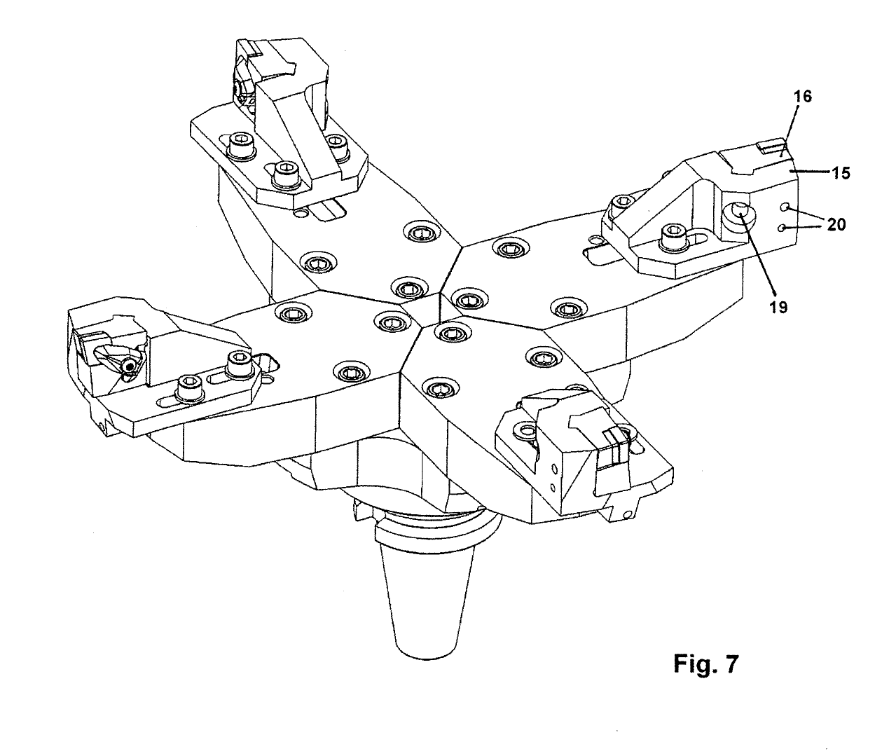

FIG. 7 shows a perspective view of the FIG. 5 embodiment,

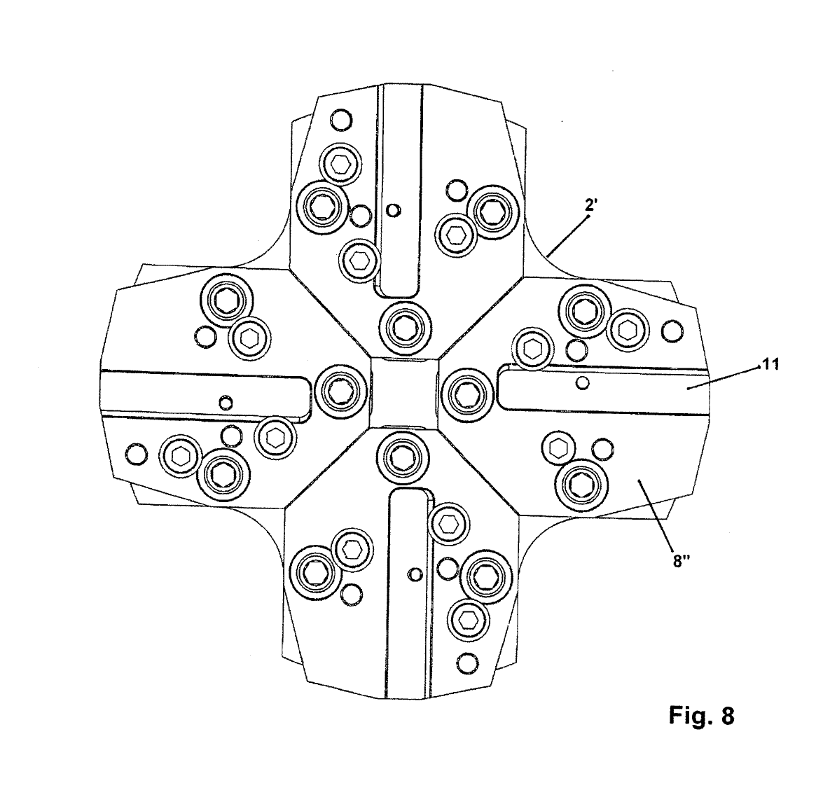

FIG. 8 shows a view from below of the main tool body of a third embodiment, fitted with extension arms,

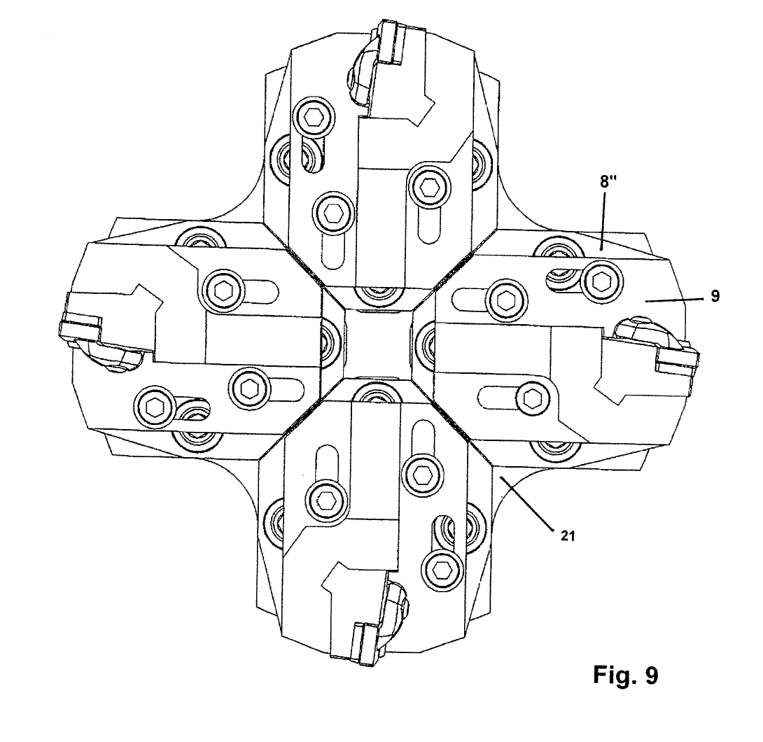

FIG. 9 shows a view from below of the FIG. 8 embodiment,

FIG. 10 shows a perspective view of the third embodiment,

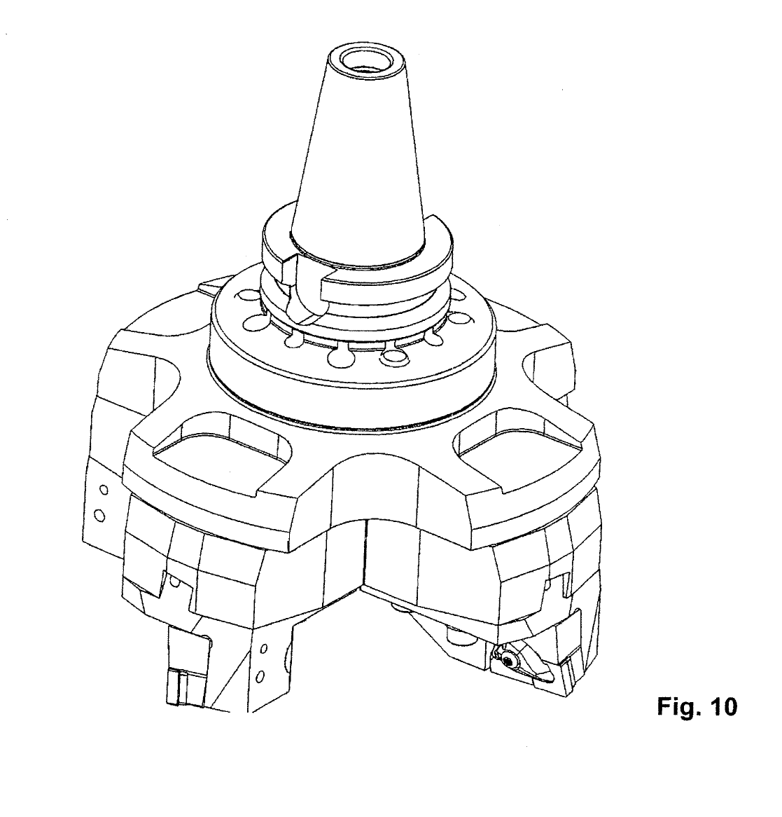

FIG. 11 shows a perspective view of the fourth embodiment,

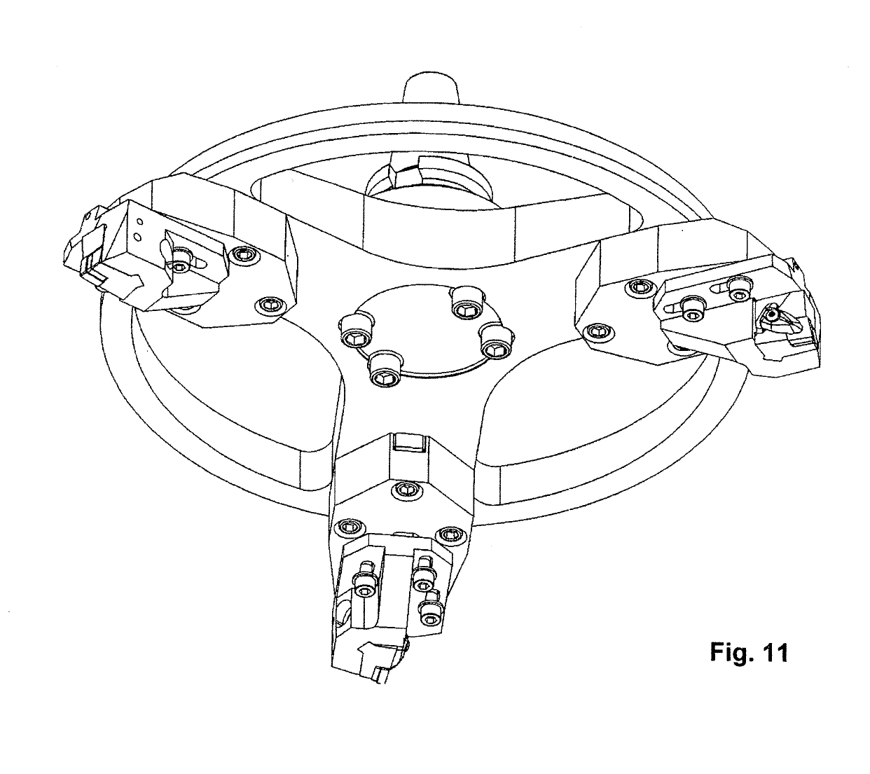

FIG. 12 shows a view from below of a fifth embodiment,

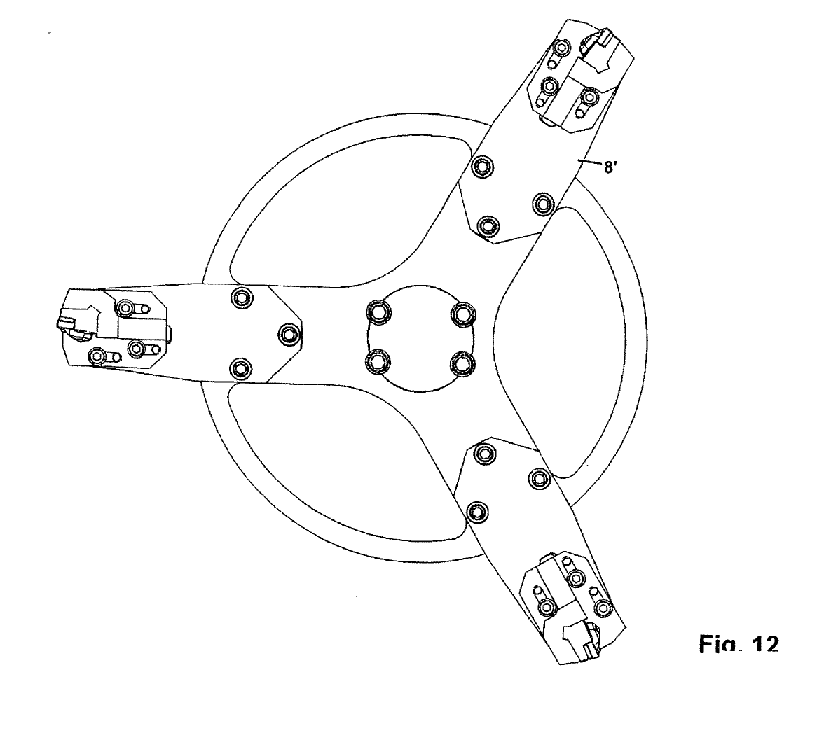

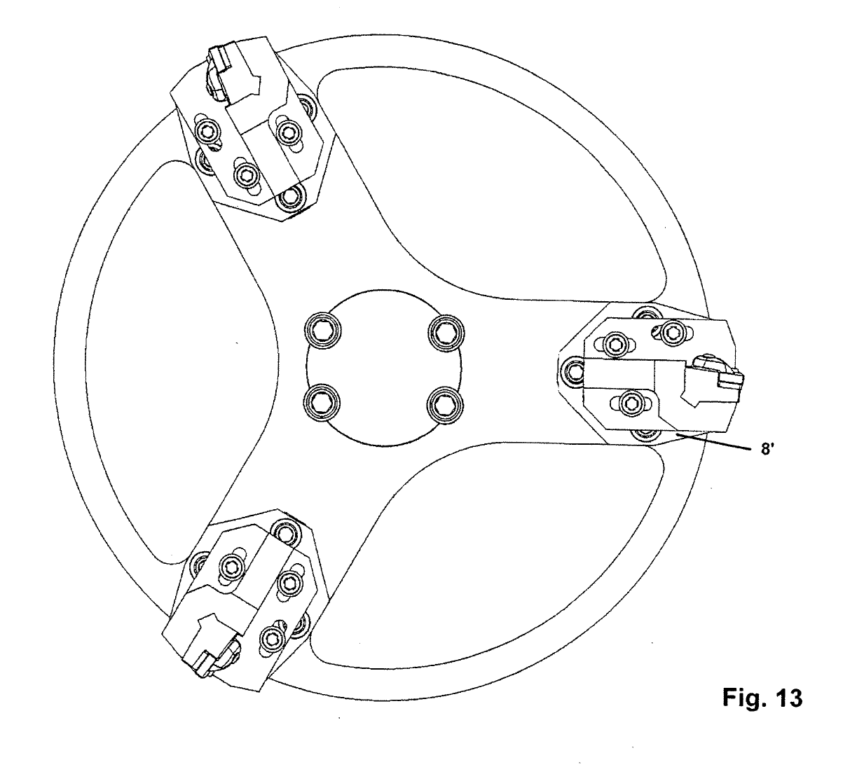

FIG. 13 shows a view from below of a sixth embodiment,

FIG. 14 shows a first perspective view of a seventh embodiment,

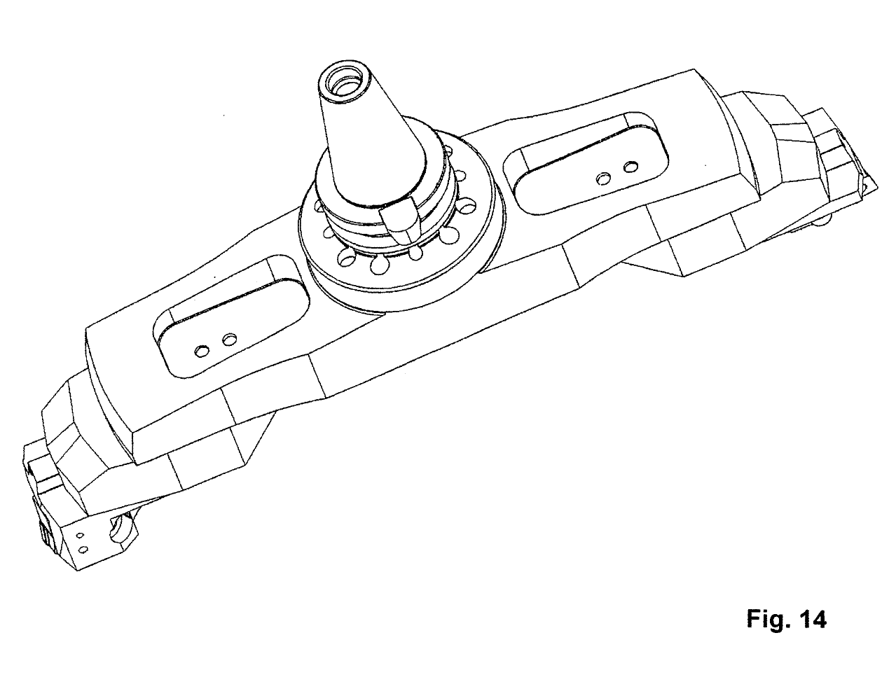

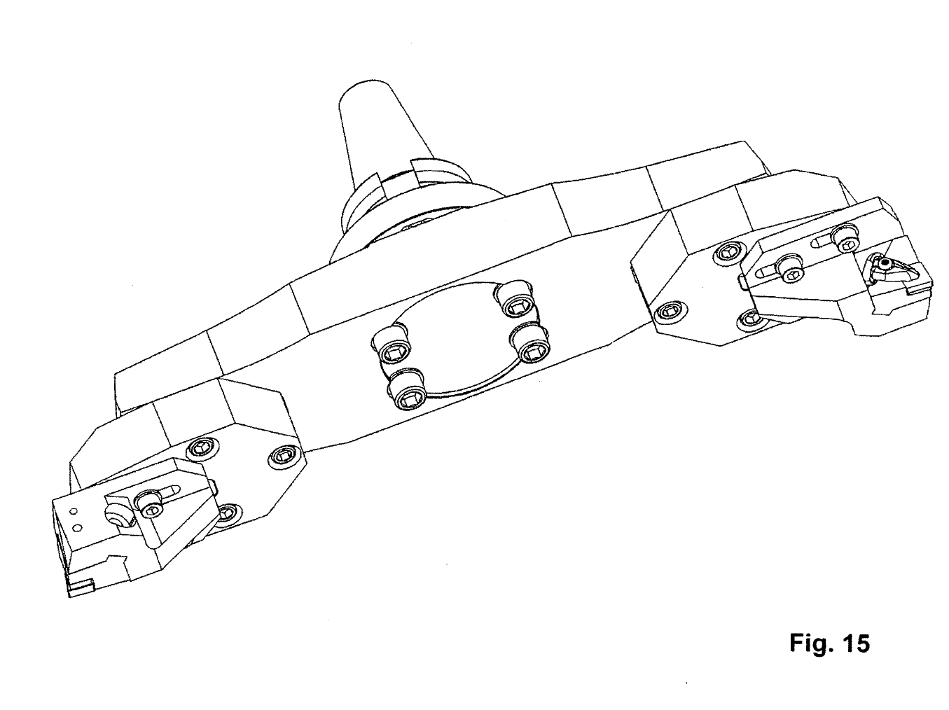

FIG. 15 shows a further perspective view of the FIG. 14 embodiment,

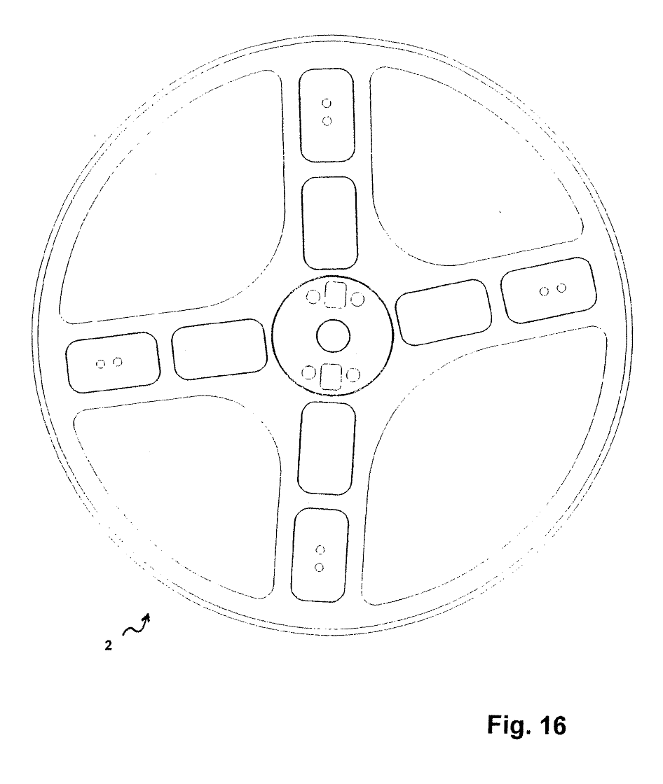

FIG. 16 shows a view from below of an eighth embodiment,

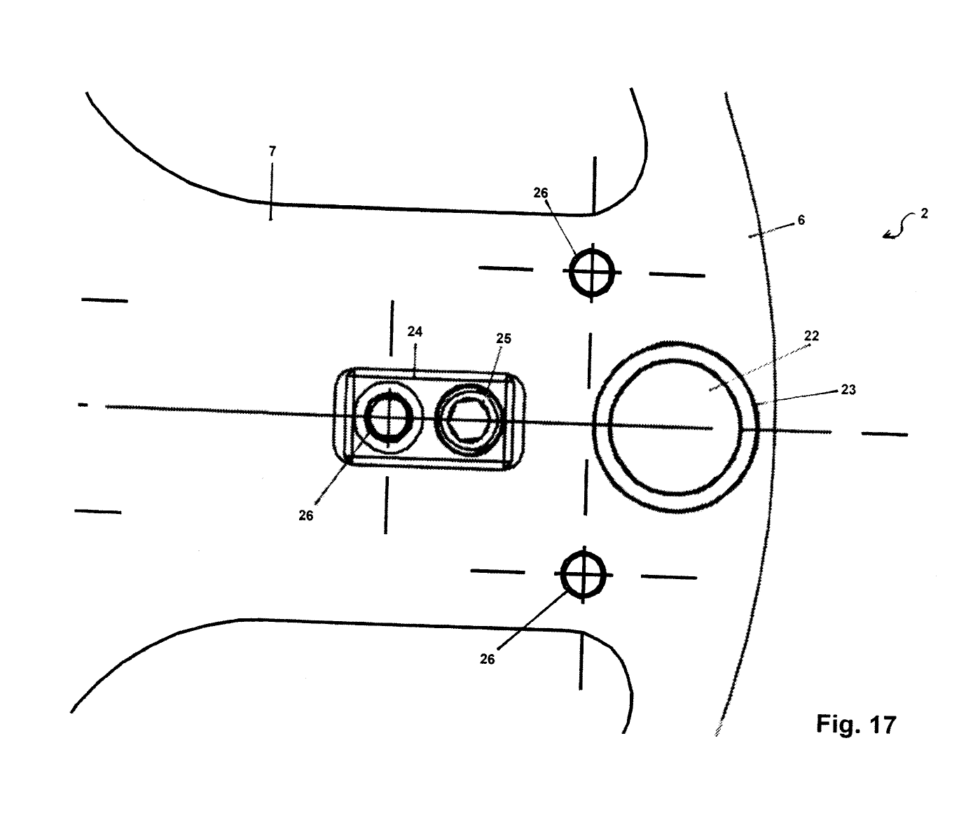

FIG. 17 shows an enlarged detail view from above of a main tool body,

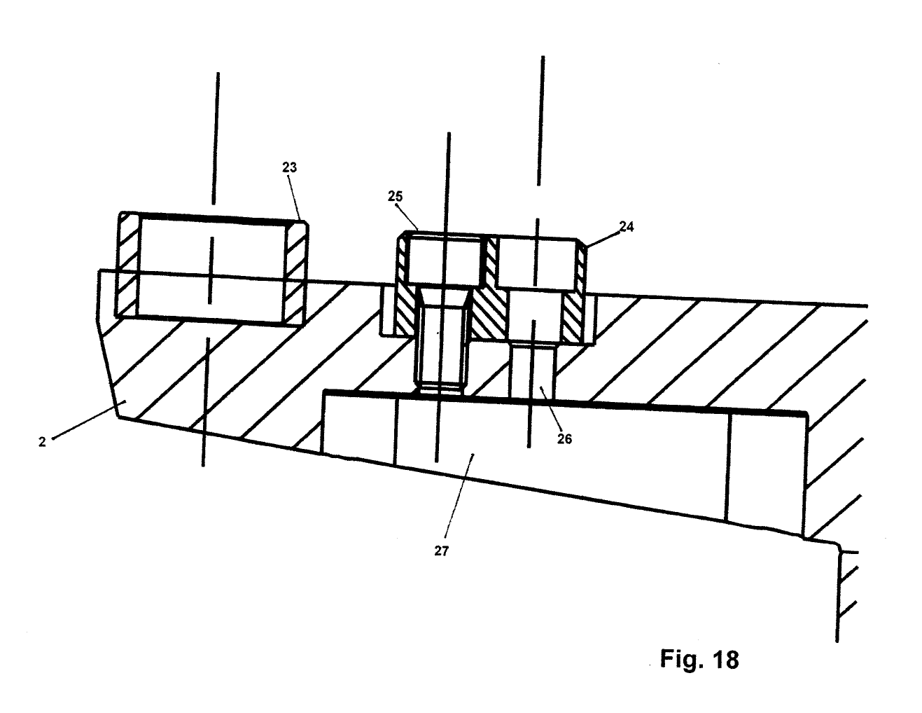

FIG. 18 shows an enlarged sectional view of the main tool body of FIG. 17,

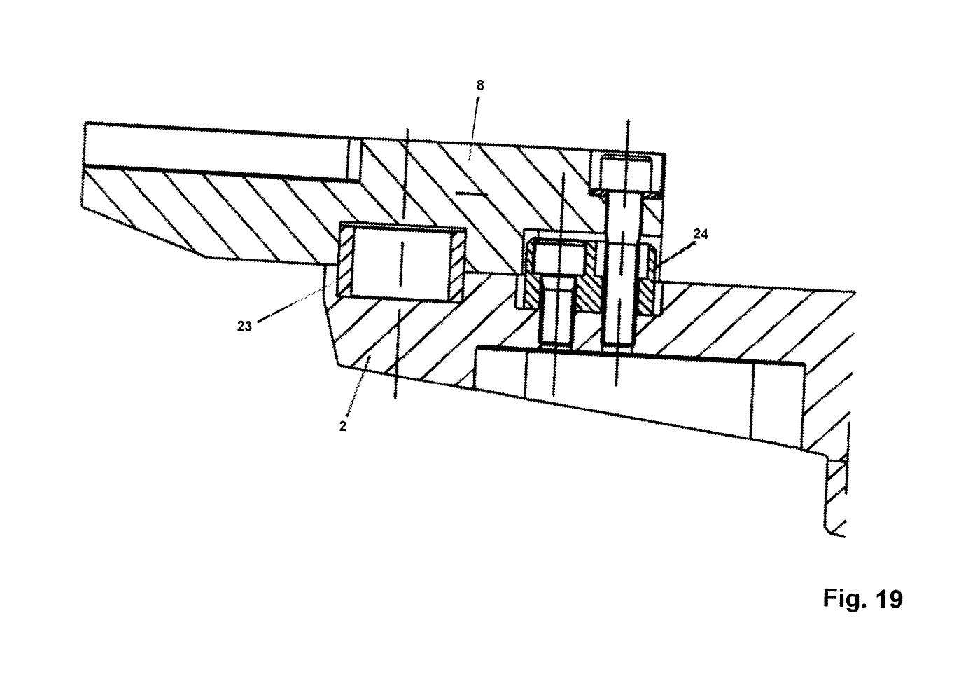

FIG. 19 shows an enlarged sectional view of the main tool body of FIG. 18 with fitted extension arm,

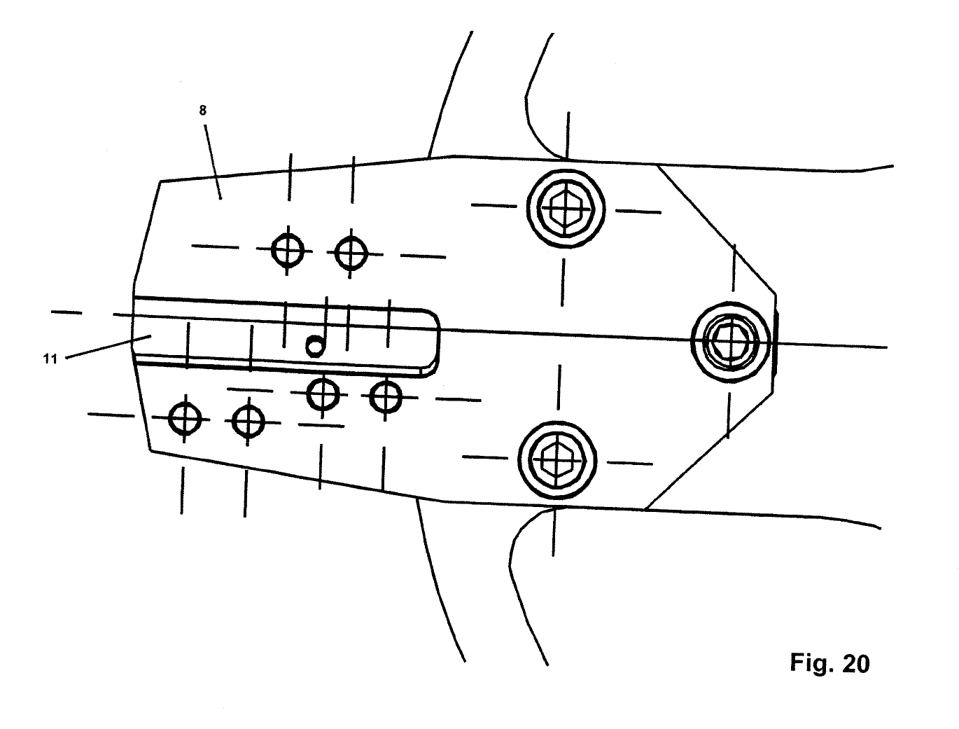

FIG. 20 shows an enlarged detail view of the main tool body of FIG. 17 with fitted extension arm,

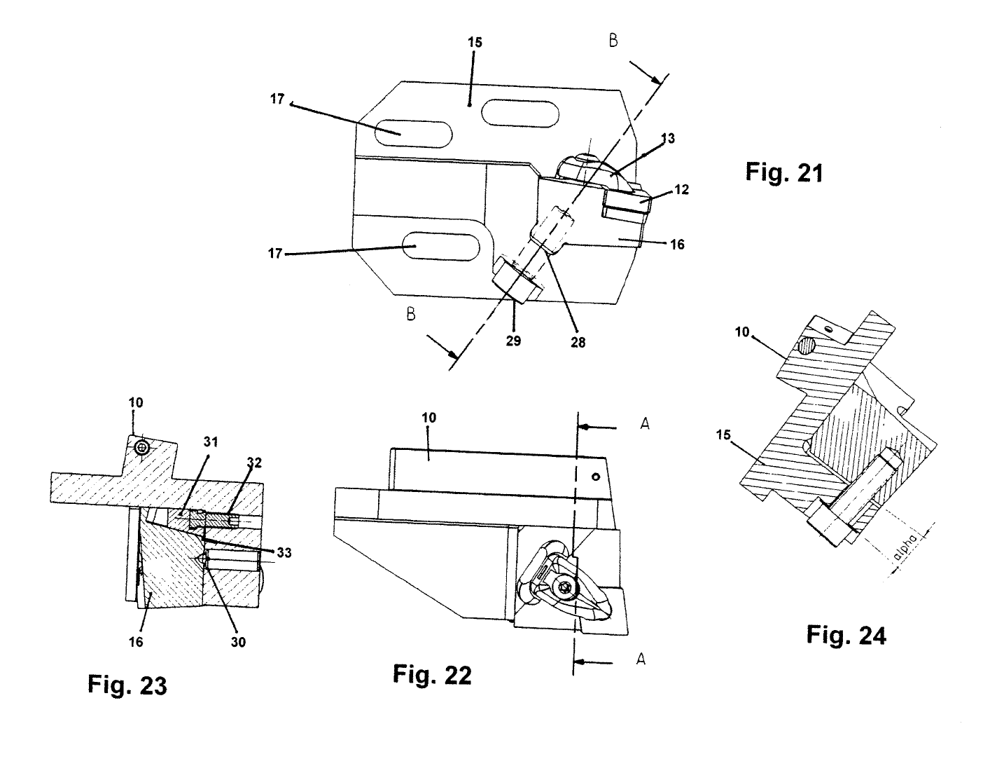

FIG. 21 shows a plan view of a slider body,

FIG. 22 shows a side view of the slider body of FIG. 21,

FIG. 23 shows a sectional view along line A-A in FIG. 22, and

FIG. 24 shows a sectional view along line B-B in FIG. 21.

FIG. 1 shows a perspective view of an embodiment of the invention. A boring-out tool 1 has a main tool body 2 which has an interface 3 with a corresponding drive. Here the interface 3 comprises a steeply tapering shaft 3, at whose end that is towards the main tool body are provided a gripping groove 4 and a flange 5 for axial support. The interface can also be in the form of a separate component which can be connected to the main tool body 2. In that case the interface desirably has a centering pin (not shown) which projects axially beyond the flange 5 and which can engage into a corresponding central bore (not shown) in the main tool body 2.

The main tool body here has a wheel-shaped portion 6 connected to an inwardly disposed hub portion by way of corresponding spoke portions 7. Extension arms 8 are mounted to the main tool body 2 or the spoke portions 7 thereof. The illustrated embodiment has four spoke portions 7, to each of which is mounted a respective extension arm 8. Carried on the extension arm 8 is a cutting insert holder 9 having a leg-like projection 10 which is disposed in a groove 11 in the extension arm 8.

FIG. 2 shows a side view of the FIG. 1 embodiment. It will be seen here that the cutting insert holder 9 has a seat for a cutting insert 12 which is held on the cutting insert holder by means of a clamp 13. It can best be seen in respect of the extension arm 8 shown in the center in FIG. 2 that the leg-like projection 10 is slightly inclined, which in operation leads to a better axial contact pressure. The screw 14 arranged within the leg-like projection 10 serves for radial displacement of the cutting insert holder 9 within the slot 11 in the extension arm 8.

FIG. 3 shows a perspective view from below and FIG. 4 shows a view from below onto the embodiment of FIGS. 1 and 2. It can be clearly seen here that the main tool body 2 comprises an inner hub portion, a wheel-shaped portion 6 and four spoke portions 7. The extension arms 8 are screwed to the spoke portions 7. The cutting insert holder 9 which in turn comprises a slider body 15 and a holding element 16 which is accommodated therein and which includes the cutting insert seat has at least one slot, in the illustrated embodiment three slots 17 can be seen. The extension arm 8 has a corresponding number of threaded bores 18 so that the cutting insert holder 9 can be radially adjusted by means of the slots 17. As already mentioned that is effected by means of the adjusting screw 14 (see FIG. 2).

It can be clearly seen from the view in FIG. 4 that the extension arm 8 has a second set of threaded bores 18. The cutting insert holder 9 can therefore be completely released from the extension arm 8 and fastened again by means of the additional threaded bores at a position radially spaced therefrom. In the new position also the slots 17 allow a certain radial displacement of the cutting insert holder relative to the extension arms 8.

To enlarge the range of boring diameters however not only can the cutting insert holder be displaced relative to the extension arm, but it is also possible to use an extension arm 8 of another configuration or a main tool body 2 of another configuration.

FIG. 5 shows a further embodiment, in which respect a main tool body 2′ of a markedly smaller diameter has been selected here. The wheel-shaped element is completely omitted and the spoke portions are very short. Fastened to the spoke portions which are very short in comparison with the embodiment of FIGS. 1 through 4 is an extension arm 8′ which is longer in comparison with the extension arm 8 in FIGS. 1 through 4, that is to say it is of an extent which is longer in the radial direction. The cutting insert holder 9 is identical to the cutting insert holder shown in FIGS. 1 through 4.

FIG. 6 is a view from below of the FIG. 5 embodiment. It will be seen that at their radially inward side the extension arms 8′ are of an acutely converging configuration so that the correspondingly acutely converging sides of adjacent extension arms 8′ almost touch each other. That acutely converging configuration has the advantage that the extension arms 8′ can be fastened further inwardly close to the boring axis.

FIG. 7 shows a further perspective view of the embodiment of FIGS. 5 and 6.

It will be clearly seen from this Figure that the holding element 16 of the cutting insert holder has a projection engaging into a corresponding groove in the slider body 15. A slot 19 serves for fastening the holding element 16 within the slider body 15. The bores 20 serve for actuating a wedge (not shown in FIG. 7), by means of which the holding element 16 can be moved to a limited extent in the axial direction, that is to say in FIG. 6 into or out of the plane of the drawing. Axial adjustability is described in greater detail with reference to FIGS. 21 through 24. That axial adjustability makes it possible for example to compensate for production deviations or step boring in which the cutting pieces are adjusted in defined relationship to different axial heights and different diameters.

FIG. 8 shows a further embodiment of the boring-out tool, wherein only the extension arms 8″ mounted on the main body 2′ can be seen in FIG. 8. If the extension arms 8″ are compared to the previous embodiments it will be seen that the extension arms are very short so that they scarcely project in the radial direction beyond the main body 2′. It is possible to clearly see here the groove 11 which serves to receive the leg 10. It is also very clearly possible to see in this view that the groove 11 is tilted with respect to a plane perpendicularly to the boring axis.

FIG. 9 differs from FIG. 8 in that the cutting insert holders 9 are mounted on the extension arms 8″. To push the cutting insert holders inwardly as far as possible they also have edge surfaces 21 which are inclined with respect to the radial direction.

FIG. 10 shows a perspective view of the FIG. 9 embodiment.

FIG. 11 shows a further embodiment. While the previous embodiments have four cutting insert holders the FIG. 11 embodiment has only three cutting insert holders.

FIG. 12 also shows a tool having three cutting edges, wherein unlike the embodiment of FIG. 11 extension arms of a greater arm length have been used. It will be appreciated that the extension arms can be fully identical to the extension arms of the embodiments of FIGS. 1 through 10. If therefore instead of a tool having four cutting edges, only a tool having three cutting edges is required, the same extension arms and the same cutting insert holders can be used. Only the main tool body has to be changed.

FIG. 13 shows a further embodiment of a boring-out tool having three cutting edges, wherein here once again the extension arms with the shortest arm length are now used.

FIGS. 14 and 15 show a further example, only two extension arms being provided here.

FIG. 16 shows a main tool body of an eighth embodiment. In this embodiment the individual spoke portions involve differential pitch division, that is to say they are not equidistantly arranged in the peripheral direction. It has been found that with this embodiment vibration which can occur in operation can be minimized.

The fastening of the extension arm 8 to the main tool body 2 will be described hereinafter with reference to FIGS. 17 through 20. FIG. 17 shows an enlarged detail view of the main tool body 2. The main tool body 2 illustrated here corresponds to the first embodiment. This manner of fixing can be used in principle not only in the illustrated embodiment, but in all main tool bodies claimed herein and obviously also generally for fastening two tool parts together.

The main tool body has a circular recess 22 (blind bore) into which a centering sleeve 23 is fitted. There is also provided a slot nut 24 which is fastened on the main tool body 2 by means of a slot nut fastening screw 25. The slot nut 24 has two through bores, of which one serves for fastening the slot nut 24 to the main tool body 2 by means of the slot nut fastening screw 25. The other bore extends coaxially relative to one of the three fastening bores 26. The fastening bores 26 serve for fastening an extension arm 8 to the main tool body 2.

It will be seen that the two through bores in the slot nut 24 and the blind bore 22 are spaced from each other only in the radial direction but not in the peripheral direction. The corresponding bores are therefore all disposed on a line as is diagrammatically shown in FIG. 17.

FIG. 18 shows a sectional view through the FIG. 17 embodiment. Shown here is the main tool body 2 which has a chamber 27 at its underside. It is also possible to see the centering sleeve 23 arranged in the blind bore 22. The axial length of the centering sleeve 23 is greater than the depth of the blind bore 22 so that the centering sleeve 23 projects in the axial direction beyond the main tool body 2. It will further be seen that the slot nut 24 is accommodated in a corresponding slot in the main tool body 2. For fastening the slot nut 24 in the slot a fastening screw 25 extends through a corresponding stepped bore in the slot nut 24 into a threaded bore in the main tool body 2. The slot nut 24 has a second stepped bore which is arranged coaxially with respect to a further threaded bore 26 in the main tool body 2.

FIG. 19 shows the same sectional view as FIG. 18, but in FIG. 19 an extension arm 8 is fastened on the main tool body 2. It will be seen that at its underside the extension arm 8 has a similarly circular recess like the main tool body 2 so that the centering sleeve 23 extends from the blind bore 22 of the main tool body 2 into the circular recess in the extension arm 8. The centering sleeve 23 provides for accurate positioning of the extension arm 8 in relation to the main tool body 2. The slot nut 24 is provided to prevent rotation of the extension arm 8 relative to the main tool body 2. At its underside the extension arm 8 has a corresponding slot into which the slot nut 24 can engage. Three fastening screws with which the extension arm 8 is screwed fast to the main tool body 2 serve for fastening the extension arm 8 to the main tool body 2. One of those screws engages through a corresponding bore in the slot nut 24 into the main tool body 2, as can be seen from FIG. 19.

FIG. 20 shows a plan view of the main tool body 2, similarly to that in FIG. 17, but in this case the extension arm 8 is fastened to the main tool body 2.

FIG. 21 shows a plan view of an embodiment of a slider body 15. The slider body 15 together with the holding element 16 forms the cutting insert holder. At its underside the slider body 15 has a leg-like projection 10 which can be fitted into a groove 11 in the extension arm 8. Three screws which engage into corresponding threaded bores in the extension arm serve for fixing the slider body 15 to the extension arm 8. Upon fixing the screws extend through corresponding slots 17 in the slider body 15 so that when the screws are released the slider body 15 can be reciprocated radially between two positions. As soon as the slider body 15 in the desired position it can be fastened to the extension arm 8 by means of the screws.

The holding element 16 has a clamp 13 with which the cutting insert 12 can be held in the holding element 16. The slider body 15 has a groove 28 in which a corresponding leg of the holding element 16 engages. A fastening screw 29 is used for fastening the holding element 16 in the groove 28.

As can be seen in particular from FIG. 24 showing a sectional view along line B-B the fastening screw 29 has some clearance in the slider body 15. The angle α shown in FIG. 24 between the bottom of the groove 28 and the contact surface for the head of the fastening screw 29 is preferably ≠0° and is best in the range between 0° and 10°.

FIG. 23 shows a sectional view along line A-A in FIG. 22. It will be seen that the holding element 16 has at its underside a bevel 33 and a V-shaped opening. The slider body 15 has a spring element 30 which is in the form of a resilient pressure portion which under the spring action projects into the opening provided for the holding element 16. In addition a wedge 31 is fastened to the slider body 15 by means of an adjusting screw 32. When the holding element 16 is fitted into the groove 28 in the slider body 15 the holding element 16 is inserted into the slider body 15 from below upwardly in FIG. 23. In that case firstly the resilient pressure portion 30 will come into engagement with the bevel 33. The bevel 33 provides that the resilient pressure portion 30 is pressed into the slider body 15 (towards the right in FIG. 23) until the V-shaped opening comes to lie opposite the pressure portion 30. That situation is shown in FIG. 23. In that situation the holding element 16 bears against the wedge 31. The wedge 31 can be moved by means of the adjusting screw 32 whereby axial displacement of the holding element 16 takes place. The spring element 30 is essentially there to push the holding element 16 along the groove 28 in the direction of the wedge 31 when the wedge 31 is moved back. As soon as the axial position of the holding element is reached the holding element 16 can be fixed to the slider body 15 by means of the fastening screw 29.

It will be appreciated that all features as can be seen by a man skilled in the art from the present description, the drawings and the claims, even if they are described in specific terms only in connection with certain other features, can be combined both individually and also in any combinations with others of the features or groups of features disclosed here insofar as that has not been expressly excluded or technical aspects make such combinations impossible or meaningless. That also applies to any combinations of features within any one of the appendant claims. A comprehensive explicit representation of all conceivable combinations of features is dispensed with here only for the sake of brevity and readability of the description.

### LIST OF REFERENCES

1 boring-out tool
2 main tool body
3 shaft
4 gripping groove
5 flange
6 wheel-shaped portion
7 spoke portion
8, 8′, 8″ extension arms
9 cutting insert holder
10 leg-like projection
11 groove
12 cutting insert
13 clamp
14 adjusting screw
15 slider body
16 holding element
17 slots
18 threaded bore
19 slot for fastening the holding element
20 bore for wedge actuation
21 edge surface
22 blind bore
23 centering sleeve
24 slot nut
25 slot nut fastening screw
26 fastening bore for slider body
27 chamber
28 slider body groove
29 fastening screw
30 spring element
31 wedge
32 adjusting screw
33 bevel

1. A boring-out tool comprising a main tool body having an interface for a drive, and a cutting insert holder which can be fastened to the main tool body and has a seat for a cutting insert, wherein the cutting insert holder can be moved in the radial direction relative to the main tool body between two positions, wherein there is provided an extension arm which on the one hand is fastened to the main tool body and which on the other hand carries the cutting insert holder, wherein the cutting insert holder can be fastened to the extension arm at least two positions which are spaced from each other in the radial direction.

2. A boring-out tool as set forth in claim 1 that wherein the boring-out tool has two, three, four or more cutting insert holders which can be fastened to the main tool body and which each have a seat for a cutting insert and can be respectively moved in the radial direction relative to the main tool body between two positions, wherein the main tool body has a hub portion and a plurality of spoke portions corresponding to the number of cutting insert holders, wherein the spoke portions extend radially substantially perpendicularly to the boring axis and wherein preferably the sides of the spoke portions, that are remote from the hub portion, are connected to the wheel-shaped portion which connects all spoke portions

3. A boring-out tool as set forth in claim 1 wherein the cutting insert holder has at least one slot and can be fastened to the extension arm by means of a screw which engages through the slot into a threaded bore in the extension arm, wherein the cutting insert holder can be fastened at different positions by releasing the screw, radially displacing the cutting insert holder and tightening the screw.

4. A boring-out tool as set forth in claim 1 wherein the cutting insert holder has at least one through hole and can be fastened to the extension arm by means of a screw which engages through the slot into a threaded bore in the extension arm, wherein the extension arm has at least two threaded bores arranged in such a way that the cutting insert holder can be fastened at different positions using the different threaded bores.

5. A boring-out tool as set forth in claim 1 wherein there are provided at least two extension arms (8, 8′) of differing length in the radial direction or at least two different sets of extension arms (8, 8′, 8″) of differing length, which can be fastened selectively between cutting insert holder and main tool body to implement different boring diameter ranges.

6. A boring-out tool as set forth in claim 1 wherein there are provided at least two main tool bodies (2, 2′) with spoke portions of differing length, which can be selectively used for receiving the extension arm to implement different boring diameter ranges.

7. A boring-out tool as set forth in claim 1 wherein in a section plane perpendicularly to the boring axis the extension arm has a portion converging conically in the direction of the boring axis, wherein the cone angle is preferably about 45° or about 180°/n, wherein n is the number of extension arms which can be fastened on the main tool body.

8. A boring-out tool as set forth in claim 1 wherein the extension arm has a groove extending substantially in the radial direction and the cutting insert holder has a corresponding leg-like projection extending substantially in the radial direction, wherein the leg-like projection can be inserted into the groove.

9. A boring-out tool as set forth in claim 8 wherein the groove has at least one groove wall which is inclined relative to a notional plane passing through the boring axis, wherein the angle of inclination is preferably between 1 and 20° and is particularly preferably about 10°.

10. A boring-out tool as set forth in claim 1 wherein the cutting insert holder comprises a slider body and a holding element accommodated in the slider body, wherein the holding element has a receiving means for a cutting insert.

11. A boring-out tool as set forth in claim 10 wherein there is provided a device for axial displacement of the cutting insert within the receiving means of the holding element.
